(19) United States
(12) Patent Application Publication
(10) Pub. No.: US 2007/0264409 A1
(43) Pub. Date: Nov. 15, 2007

(54) Food Preparation with a Creamy Consistency for Use as a Base for Sauces

(75) Inventors: Adriano Festa, Parma (IT); Michele Mascaro, Cavriago (Reggio Emilia) (IT); Franco Dameno, Piacenza (IT)

Correspondence Address: AKERMAN SENTERFITT, P.O. BOX 3188, WEST PALM BEACH, FL, 33402-3188, US

(73) Assignee: Barilla Alimentare S.p.A., Parma (IT)

(21) Appl. No.: 11/759,033

(22) Filed: Jun. 6, 2007

Related U.S. Application Data
(63) Continuation-in-part of application No. 10/705,341, filed on Nov. 10, 2003, now abandoned.

(30) Foreign Application Priority Data
Apr. 11, 2003 (IT) MI2003A 000767

(51) Int. Cl. A23L 1/39

(52) U.S. Cl. 426/589

(57) ABSTRACT

A pasteurized foodstuff preparation of creamy consistency, to be used as a base for sauces, containing, in percentage of weight per total weight, 10 to 30% of edible fats, and about 50 to 70% of at least one organoleptically characterizing ingredient of vegetal origin, selected from the group consisting of fresh mushrooms and fresh vegetables. The preparation has a water activity (Aw) less than or equal to 0.95 and a pH lower than or equal to 5.0. The at least one organoleptically characterizing ingredient is included in part in a finely subdivided form and in part in discrete pieces within the foodstuff preparation, the discrete pieces being in the range of 3-8 mm. The foodstuff preparation is free from artificial ingredients.

### CROSS-REFERENCE TO RELATED APPLICATION

This Application is a continuation-in-part of co-pending U.S. application Ser. No. 10/705,341, filed on Nov. 10, 2003, which claims priority to Italian Patent Application No. MI 2003A 000767, filed Apr. 11, 2003. The entire contents of the earlier applications are incorporated herein by reference.

### TECHNICAL FIELD

The present invention refers, in general, to the technical sector of the foodstuff industry.

In particular, the invention concerns a concentrated food preparation suitable as the basic ingredient for the prompt production of sauces to serve with foods such as pasta, rice and the like.

### BACKGROUND OF THE INVENTION

So-called ready-to-use sauces are well known to consumers, i.e., sauces based on tomatoes or on cream, béchamel or the like, and which are produced according to traditional recipes by adding organoleptically characterizing ingredients such as, for example mushrooms, green vegetables, garlic, onion, etc.

Ready-to-use sauces are commonly packed in small glass jars or in tins and their conservation at room temperature is achieved by heat sterilization or pasteurization under quite drastic conditions.

These ready-to-use sauces have the great advantage of being ready to use but it is also known that the organoleptic properties of ready-to-use sauces never reach the analogous properties of freshly produced sauces, especially because they have been subjected to sterilization or pasteurization processes under drastic conditions that tend to attenuate flavor, or sometimes even modify it.

Also known are concentrated tomato based products, like the so-called double tomato concentrate that consists of tomato pulp subjected to a concentration process aimed at notably reducing water content and ensuring conservation.

These tomato concentrates are commonly used in the domestic preparation of sauces after appropriate dilution with water and the addition of organoleptically characterizing ingredients.

It is evident that tomato concentrates do not have the advantage of being a final product but are simply a substitute for fresh tomato.

### SUMMARY OF THE INVENTION

The problem underlying the present invention is to make available a preparation for making, with great ease and minimal preparation times and according to traditional recipes, sauces that present organoleptic properties fully comparable with those of analogous sauces prepared with fresh ingredients.

This problem has been solved, according to the invention, by a pasteurized food preparation of creamy consistency containing, in weight percentage on total weight, 10 to 30% of edible fats, and about 50 to 70% of at least one organoleptically characterizing ingredient of vegetal origin, selected from the group consisting of fresh mushrooms and fresh vegetables, the preparation having a water activity (Aw) less than or equal to 0.95 and a pH lower than or equal to 5.0. The at least one organoleptically characterizing ingredient is included in the food preparation in part in a finely subdivided form and in part in discrete pieces which are in the range of 3-8 mm. The foodstuff preparation is also free from artificial ingredients.

Preferably the water activity of the preparation according to the invention is between 0.86 and 0.94 and the pH between 4.0 and 5.0.

The moisture content of the food preparation according to the invention is generally between 50 and 70%.

The edible fats contained in the preparation according to the invention are preferably selected from among vegetable oils with a low saturated fatty acid content, such as the oils of maize, peanuts, sunflowers, soy, grape seeds and olives. Olive oil is particularly preferred.

The pH can be adjusted by adding small quantities of organic acids of alimentary use, like citric, tartaric and lactic acids or else lemon juice or vinegar

The preparation according to the invention can furthermore contain aromatic herbs, salt, spices and natural flavorings.

The preparation according to the invention can be conveniently packaged in association with an essentially liquid, water-based foodstuff, like tomato juice or tomato pulp, cream, béchamel, milk and yogurt, which is intended to dilute the said foodstuff preparation. The foodstuff preparation and the water-based foodstuff intended to dilute the foodstuff preparation can be supplied in separate containers within a kit or packaging, such that a consumer can mix the foodstuff preparation with the water-based foodstuff at the time of final preparation of the sauce just prior to consumption thereof.

Given the accurate control of A_{w} and pH, the preparation according to the invention becomes preservable following only a mild pasteurizing heat treatment (e.g. at temperatures no higher than 100° C. for 1-3 minutes), whereas known ready-to-use sauces obligatorily require more drastic thermal treatment.

There is also no need to add stabilization agents to the preparation in order to help preserve the preparation. The preparation according to the invention is free from artificial ingredients, such as artificial stabilizers, emulsifiers, preservatives, coloring agents, and the like, although starch may be added as a thickening agent and organic acids as pH regulators.

In this way, there is the maximum safeguarding of the organoleptic properties of the organoleptically characterizing ingredients.

The achievement of the low water activity value of the preparation according to the invention is permitted by the concentration treatment to which the organoleptically characterizing ingredients of vegetal origin are subjected before being mixed with other ingredients. Such concentration treatment is carried out under mild conditions and consists in the evaporation of water through heating, possibly at reduced pressure for those vegetables more susceptible to degradation.

Advantageously, the concentration is carried out in such manner as to obtain at the end a creamy product incorporating partially dehydrated particles of the same ingredient (e.g., a cream of peppers that contains small pieces of the said peppers).

The preparation according to the invention is to be used as a base to obtain sauces by means of simple dilution with oil, tomato sauce, cream, béchamel or the like.

For example, a preparation according to the invention, containing mushrooms as the characterizing organoleptic ingredient, allows the obtaining of a mushroom sauce simply by adding tomato pulp or tomato sauce, mixing, followed by heating in a saucepan or a microwave oven. Alternatively the above preparation can be diluted with oil, cream, béchamel, milk, butter or yogurt to obtain a white mushroom sauce.

The invention also relates to a process for the production of the foodstuff preparation. The method includes the steps of reducing the at least one organoleptically characterizing ingredient of vegetal origin into pieces of appropriate size, subjecting it to a concentration treatment under mild heat conditions, in order to take the water activity (Aw) to a value lower than or equal to 0.95. The method further includes blending to the consistency of a cream a portion of the concentrated at least one organoleptically characterizing ingredient, mixing the said ingredient pieces and cream consistency portion with edible fats and, optionally, further ingredients selected from aromatic herbs, salt, spices and/or natural flavorings, and adjusting the pH of the thus obtained mixture to a value lower than 5.0 and subjecting said mixture to a mild pasteurization treatment. The concentration step leads to a reduction in the volume of the foodstuff preparation of between 55 and 65% of the initial volume.

One advantage evident from what has been stated regarding the preparation according to the invention is its versatility.

But the biggest advantage of the foodstuff preparation according to the invention lies in the organoleptic characteristics of the final sauce that is obtained by using the said preparation. Such characteristics do not fear comparison with those of an analogous sauce prepared promptly from fresh ingredients.

### DETAILED DESCRIPTION OF THE INVENTION

Further characteristics and advantages of the preparation according to the invention are highlighted by several examples, given in the following as illustrative and not limiting.

### EXAMPLE 1

Mushroom sauce

| | |
|---|---|
| Olive oil | 30% |
| Mushrooms | 51% |
| Starch | 8% |
| Aromatic herbs and spices | 7% |
| Salt | 2% |
| Lemon juice | 2% |

The above reported percentages are intended as weight per total weight of the preparation.

Fresh mushrooms with a moisture content around 90% were subjected to thermal treatment under vacuum to reduce the said moisture content to values around 60-70%. A part of the partially dehydrated mushrooms was reduced to a creamy consistency while the remaining mushrooms were reduced to pieces and added to the cream. The pieces of mushroom were between 3 and 8 mm.

Finally there was the incorporation of olive oil, starch, aromatic herbs, lemon juice, salt and spices, obtaining a creamy preparation with a moisture content of 65%.

The water activity of the thus obtained preparation was 0.89 and the pH 4.2.

The preparation was then put into 100 ml jars and subjected to pasteurization at a temperature of 100° C. for 1-2 minutes.

### EXAMPLE 2

| | |
|---|---|
| Oil | 25% |
| Peppers | 50% |
| Anchovies | 6% |
| Starch | 8% |
| Aromatic herbs and spices | 7% |
| Salt | 2% |
| Lemon juice | 2% |

The above reported percentages are intended as weight per total weight of the preparation.

The peppers were subjected to thermal treatment under vacuum to reduce their moisture content to values around 65%. A part of the partially dehydrated peppers was reduced to a creamy consistency while the remaining peppers were reduced to pieces and added to the cream.

Finally there was the incorporation of olive oil, finely chopped anchovies, starch, aromatic herbs, salt, lemon juice and spices, obtaining a creamy preparation with a moisture content of 63%.

The water activity of the thus obtained preparation is 0.90 and the pH 4.3.

The preparation was then put into 100 ml jars and subjected to pasteurization at a temperature of 98° C. for 1-2 minutes.

### TEST OF ORGANOLEPTIC EVALUATION

The concentrate preparation obtained according to Example 1, after conservation at 20° C. for 30 days, was diluted with cream and milk in a ratio of preparation:cream:milk weight of 3:6:1 and was evaluated by a panel of tasters, comparing it with a mushroom sauce having the same qualitative and quantitative composition as the sauce obtained by diluting the concentrate preparation of Example 1 as just described, but prepared according to the classic procedure that does not foresee the initial concentration of the mushrooms nor the pasteurization, but only sterilization. Also this comparison sauce was kept at 20° C. for 30 days.

The two sauces for comparison were used to dress spaghetti of identical format, using a weight ratio of pasta/sauce equal to 1.

The tasters were asked to evaluate, in relation to different parameters, both the fragrance and the taste of the two sauces, and the results are summarized for comparison purposes in tables 1 and 2.

TABLE 1
Profile of flavor/fragrance

| | Sauce obtained by | Sterilized sauce for |
|---|---|---|
| | preparation Ex. 1 | comparison |
| Balance/fullness | 5 | 4 |
| Mushrooms | 5 | 4 |
| Milkiness | 4 | 4 |
| Cream/fattiness | 4 | 4-5 |
| Earthiness | 3 | 3 |
| Sweetness | 4 | 3 |
| Aromatic herbs | 3 | 2 |
| Saltiness | 3 | 3 |
| Cheese | 3 | 2 |
| Garlic | 4 | 2 |
| Bitterness | 3 | 3 |
| Spices/pepper | 2 | 2 |
| Acidity | 2-3 | 3 |

TABLE 2
Profile of Taste

| | Sauce obtained by | Sterilized sauce for |
|---|---|---|
| | preparation Ex. 1 | comparison |
| Balance/fullness | 4-5 | 4 |
| Mushroom | 5 | 3-4 |
| Milkiness | 4 | 4 |
| Creamy/fattiness | 4 | 5 |
| Earthiness | 3 | 3 |
| Sweetness | 4 | 3-4 |
| Aromatic herbs | 3 | 2 |
| Saltiness | 4 | 3 |
| Cheese | 3 | 3 |
| Garlic | 3-4 | 3 |
| Bitterness | 2-3 | 3 |
| Spices/pepper | 2-3 | 2 |
| Acidity | 3 | 3 |
| Starchiness | 3 | 3 |
| Waxiness | 3 | 3-4 |
| Wateriness | 3 | 3-4 |
| Oiliness | | 2-3 |
| Flour | 2 | |
| Binding in mouth | 3 | 3 |
| Metallic | 2-3 | 2-3 |
| Cause mouthwatering | 3 | 3 |

From the data in the previous tables it is understood that the sauce obtained by the concentrate preparation according to example 1 is fuller and more fragrant than the sterilized sauce for comparison. In addition, with regard to fragrance there was a more intense aroma of mushrooms, the organoleptically characterizing ingredient, and of aromatic herbs and sweetness.

With regard to taste, once again there was a greater intensity of mushroom notes and furthermore the sauce obtained using the preparation according to the invention was less cream tasting and less fatty at the tasting.

Furthermore it is worth noting that in the sauce obtained from the preparation according to the invention there is the absence of the touch of oiliness noted in the compared sterilized preparation.

Finally, the sauce obtained by the concentrated preparation according to the invention demonstrated a decidedly better dressing quality than that of the comparison preparation.

1. A pasteurized foodstuff preparation of creamy consistency, to be used as a base for sauces, containing, in percentage of weight per total weight, 10 to 30% of edible fats, and about 50 to 70% of at least one organoleptically characterizing ingredient of vegetal origin, selected from the group consisting of fresh mushrooms and fresh vegetables, the preparation having a water activity (Aw) less than or equal to 0.95 and a pH lower than or equal to 5.0,
wherein the at least one organoleptically characterizing ingredient is included in part in a finely subdivided form and in part in discrete pieces within the foodstuff preparation,
wherein the discrete pieces of the organleptically characterizing ingredient are in the range of 3-8 mm, and
wherein the foodstuff preparation is free from artificial ingredients.

2. A foodstuff preparation according to claim 1, wherein the water activity lies between 0.86 and 0.94.

3. A foodstuff preparation according to claim 1, wherein the pH is between 4.0 and 5.0.

4. A foodstuff preparation according to claim 1, wherein said edible fats are chosen from among vegetal oils with a low saturated fatty acid content.

5. A foodstuff preparation according to claim 4, wherein said oils are chosen from the group consisting of oil of maize, peanuts, sunflowers, soy, grape seeds and olives, and mixtures thereof.

6. A foodstuff preparation according to claim 1, containing further aromatic herbs, salt, spices and/or natural flavorings.

7. A kit for the preparation of a sauce to dress pasta and rice, including a pasteurized food preparation according to claim 1 and an essentially liquid and water-based foodstuff, which is intended to dilute the said food preparation.

8. A kit according to claim 7, wherein the essentially liquid and water-based foodstuff is selected from the group consisting of tomato sauce or pulp, cream, béchamel, milk and yogurt.

9. A process for the production of a foodstuff preparation containing, in percentage of weight per total weight, 10 to 50% of edible fats, and about 50 to 70% of at least one organoleptically characterizing ingredient of vegetal origin, selected from the group consisting of fresh mushrooms and fresh vegetables, and being present in part in finely subdivided form and in part in the form of discrete pieces, the preparation having a water activity (Aw) less than or equal to 0.95 and a pH lower than or equal to 5.0, the method including the steps of:
reducing said at least one organoleptically characterizing ingredient of vegetal origin into pieces of appropriate size;
subjecting it to a concentration treatment under mild heat conditions, in order to take the water activity (Aw) to a value lower than or equal to 0.95;
blending to the consistency of a cream a portion of the concentrated at least one organoleptically characterizing ingredient;
mixing the said ingredient pieces and cream consistency portion with edible fats and, optionally, further ingredients selected from aromatic herbs, salt, spices and/or natural flavorings; and
adjusting the pH of the thus obtained mixture to a value lower than 5.0 and subjecting said mixture to a mild pasteurization treatment,
wherein the concentration step leads to a reduction in the volume of the foodstuff preparation of between 55 and 65% of the initial volume.
